(19) United States
(12) Patent Application Publication
(10) Pub. No.: US 2022/0301791 A1
(43) Pub. Date: Sep. 22, 2022

(54) SEMI-INDEPENDENT SWITCH-DISCONNECTOR

(71) Applicant: Eaton Intelligent Power Limited, Dublin (IE)

(72) Inventors: Asad Mujawar, Pune (IN); Kris Bednarski, Loughborough (GB); Varsha Sabale, Pune (IN)

(21) Appl. No.: 17/640,370

(22) PCT Filed: Sep. 4, 2020
(86) PCT No.: PCT/EP2020/074723

§ 371 Date: Mar. 4, 2022

(30) Foreign Application Priority Data
Sep. 5, 2019 (IN) 201911035835
Nov. 20, 2019 (GB) 1916868.1

(51) Int. Cl. H01H 19/14; H01H 19/12; H01H 1/20

(52) U.S. Cl. CPC H01H 19/14; H01H 19/12; H01H 1/20

(57) ABSTRACT

A disconnector includes: a switch having: a first, fixed contact terminal of a first conductor, a second, fixed contact terminal of a second conductor, and a moveable bridge contact moveable between a first position and a second position; and an actuating mechanism having: a cam follower coupled to the moveable bridge contact and including a following surface, a cam having a cam surface, the cam surface engaging with the following surface, the cam being rotatable around an axial direction relative to the cam follower. At least one of the following surface and the cam surface includes an angled portion, the angled portion angled with respect to the axial direction such that rotation of the cam urges the cam follower in the axial direction, the cam follower moving the moveable bridge contact in the axial direction from the first position to the second position in response to the urging.

### CROSS-REFERENCE TO PRIOR APPLICATIONS

This application is a U.S. National Phase application under 35 U.S.C. § 371 of International Application No. PCT/EP2020/074723, filed on Sep. 4, 2020, and claims benefit to British Patent Application No. GB 1916868.1, filed on Nov. 20, 2019, and to Indian Patent Application No. IN 201911035835, filed on Sep. 5, 2019. The International Application was published in English on Mar. 11, 2021 as WO 2021/043957 under PCT Article 21(2).

### FIELD

This relates to a switch-disconnector for opening, or interrupting, a current conduction path. In particular, this relates to a switch-disconnector with semi-independent operation for interrupting a current conduction path.

### BACKGROUND

A switch-disconnector, disconnect switch or isolator switch is used to break a current conduction path to ensure that an electrical circuit is de-energized and safe for service or maintenance. Such switch-disconnectors or switches are often found in electrical distribution and industrial applications. Switch-disconnectors can be operated either manually or automatically.

Manual switch disconnectors can be either independent (of a user input, i.e. the switch is simply switched on or off) or dependent, where the speed of the switching operation is controlled by user input (i.e. the speed of actuation by the user), or a combination of the two. For example, a manual dependent operation can control the make of the switch, whilst an independent operation (initiated by a user and then independent of user input) can be used to break the switch (or vice versa). This operation can be termed semi-independent.

There is a need for a simpler switch disconnector with semi-independent operation, which has a reduced manufacturing/assembly cost and complexity as compared to other known disconnectors.

DE10210228A1 discloses a movable switching bar in a housing with at least one contact bridge corresponding to the number of phases for making electrical connections between input and output contact arrangements on opposite dies of the switching bar. The switching bar is vertically movable by a cam element and can be latched in different switch positions by a spring-loaded cam system.

U.S. Pat. No. 6,072,128 discloses a rotary-controlled multipole electric switch fitted with a handle and a housing in which a cam device transforms the rotation of the handle into a translational movement of contact bridges. In order to ensure coordination between a cylindrical control core and a slider 16 bearing contact bridges, the cam device is fitted with at least two notches offset around the axis of rotation X of the knob, and with a control projection applied respectively to the bottom of one notch in the OFF position and to the bottom of the other notch in the ON position by the force supplied by springs acting on the slider and contact pressure springs.

### SUMMARY

In an embodiment, the present invention provides a disconnector, comprising: a switch, comprising: a first, fixed contact terminal of a first conductor, a second, fixed contact terminal of a second conductor, and a moveable bridge contact moveable between a first position and a second position; and an actuating mechanism, comprising: a cam follower coupled to the moveable bridge contact and comprising a following surface, a cam comprising a cam surface, the cam surface being configured to engage with the following surface, the cam being rotatable around an axial direction relative to the cam follower, wherein at least one of the following surface and the cam surface comprises an angled portion, the angled portion angled with respect to the axial direction such that rotation of the cam urges the cam follower in the axial direction, the cam follower being configured to move the moveable bridge contact in the axial direction from the first position to the second position in response to the urging, and wherein the disconnector further comprises two biasing members configured to, upon movement of the moveable bridge contact in the axial direction, exert a force on the moveable bridge contact in a direction opposite the axial direction to oppose the movement, one biasing member being arranged at each end of the moveable bridge contact.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1: FIG. 1A illustrates a perspective view of a switch-disconnector, and FIG. 1B illustrates an exploded perspective view of the switch-disconnector of FIG. 1B;

FIG. 2: FIG. 2A illustrates a perspective view of an example urging member of a switch disconnector, and FIG. 2B shows a perspective view of an example cam follower corresponding to the urging member;

FIG. 3: FIG. 3A illustrates a perspective view of an example switch disconnector in a make position, and FIG. 3B illustrates a perspective view of the example switch disconnector in a break position; and

FIG. 4: FIG. 4A illustrates a schematic side view of an example switch disconnector, and FIG. 4B illustrates a schematic side view of an alternative switch disconnector to that of FIG. 4A.

### DETAILED DESCRIPTION

In an embodiment, the present invention provides a switch-disconnector as described herein. Features described herein can be combined in any suitable combination. The term “switch-disconnector” is used herein, but it will be understood that the principles described herein can apply equally to other disconnectors or disconnector devices such as circuit breakers, load disconnectors or any other form of electrical disconnection or isolation device.

Described herein is a disconnector, or switch disconnector, comprising: a switch and an actuating mechanism. The switch comprises a first, fixed, contact terminal of a first conductor, a second, fixed, contact terminal of a second conductor, and a moveable bridge contact moveable between a first position and a second position. The actuating mechanism comprises: a cam follower comprising a following surface; an urging member comprising a cam surface, wherein the urging member is rotatable around an axial direction relative to the cam follower, and wherein at least one of the following surface and the cam surface comprises an angled portion, the angled portion angled with respect to the axial direction such that rotation of the urging member urges the cam follower in the axial direction, wherein the cam follower is configured to move the moveable bridge contact from the first position to the second position in response to the urging; and a biasing member configured to act on the moveable bridge contact to oppose the movement of the moveable bridge contact in the axial direction.

In some examples, the biasing member is resiliently deformable. The device may therefore work in either tension or compression, allowing for semi-independent make or break operation. Optionally, the biasing member comprises a spring which is configured to compress as the moveable bridge contact is urged in the axial direction. The disconnector may therefore be cheaper and easier to assemble.

Optionally, the biasing member comprises two or more springs (optionally three springs) arranged equidistant along a length of the moveable bridge contact, each configured to compress as the moveable bridge contact is urged in the axial direction. This arrangement can improve stability and reliability of a semi-independent make or break operation (i.e. an operation at least partially independent of user input) by improving control of the user independent motion of the bridge contact 108. For example, the bridge contact may wobble less.

Optionally, where there are three or more springs, one or more middle springs can be initially configured to compress as the cam follower is urged in the axial direction. This can help prevent accidental operation of the device, and provide robustness against accidental input since the bridge contact is only moved after a predetermined amount of rotational input is applied.

In one example, the first and second fixed contacts are arranged between the cam follower and the moveable bridge contact, such that: in the first position the moveable bridge contact is in electrical contact with the first and second fixed contact terminals to define a current conduction path between the first conductor and the second conductor, and in the second position the moveable bridge contact is electrically and physically separate from the first and second fixed contact terminals and the current conduction path is open, controlled break operation and an at least partially independent make operation can therefore be provided. This can allow the switch make to be achieved quickly, which can be of benefit in applications were rapid electrical connection is required.

In another example, the moveable bridge contact is arranged between the cam follower and the first and second fixed contacts, such that: in the second position the moveable bridge contact is in electrical contact with the first and second fixed contact terminals to define a current conduction path between the first conductor and the second conductor, and in the first position the moveable bridge contact is electrically and physically separate from the first and second fixed contact terminals and the current conduction path is open.

A controlled make operation and an at least partially independent break operation can therefore be provided. This can allow the switch break to be achieved quickly, which can be of benefit in applications were rapid electrical disconnection is required.

Optionally, the cam surface comprises a protruding portion and the following surface comprises a detent or recess, the protruding portion configured to be received by the detent; this alignment of the protruding portion and recess can define a stop position of the urging member, wherein when the urging member is in the stop position the moveable bridge contact is in the second position. In this way, user input can be required to operate the subsequent make/break of the switch, since the protruding portion needs to be released from the stop. Accidental operation may therefore be prevented.

Optionally, the urging member is fixed in the axial direction; this can improve the efficiency of the urging of the cam follower, and facilitate a smaller disconnector device. Optionally, both the following surface and the cam surface comprise corresponding angled portions which are in contact with one another when the moveable bridge contact is in the first position. This can facilitate a smaller disconnector device, since the cam portions of the urging member and cam follower can be at least partly nested.

Optionally the angled portion is angled such that the urging of the moveable bridge contact in the axial direction from the first position to the second position is dependent on user input, and movement of the moveable bridge contact towards the first position by the biasing mechanism is at least partially independent of user input.

Optionally the disconnector further comprises a housing configured to enclose the switch and the actuating mechanism. Optionally the housing comprises two portions, a front/top portion and a rear/bottom portion. The manufacturing and construction of the switch disconnector may therefore be quicker and cheaper. Optionally, the front portion may be at least substantially flat. A smaller disconnector may therefore be provided, and fewer materials may be needed for manufacturing the disconnector. The disconnector described herein may therefore be cheaper and require fewer resources to manufacture than other disconnectors.

Optionally, the disconnector further comprises a second switch, wherein the cam follower is also configured to move the moveable bridge contact of the second switch in response to the urging, and wherein the actuating mechanism comprises a second biasing member configured to act on the moveable bridge member of the second switch. Higher rated devices may therefore be isolated with the disconnector.

Optionally, the switch and the second switch are arranged along a direction perpendicular to the axial direction. This arrangement can be particularly space efficient, and can allow for a smaller and more compact device to be provided.

Described herein is a method of operating a disconnector, optionally a disconnector of any example described herein. The method comprises: rotating in a first direction, to a stop position, an urging member around an axial direction relative to a cam follower, the urging member comprising a cam surface and the cam follower comprising a following surface, wherein at least one of the following surface and the cam surface comprises an angled portion, the angled portion angled with respect to the axial direction; and in response to the rotating: urging the cam follower in the axial direction to urge a moveable bridge of a switch in the axial direction from a first position to a second position to open or close the switch, the moveable bridge configured to move in response to the urging of the cam follower, and opposing, with a biasing member, the urging of the moveable bridge.

Optionally, the method further comprises: rotating the urging member in a second direction opposite to the first direction to rotate the urging member past the stop position; and moving, by the biasing member, the moveable bridge towards the first position to close or open the switch.

Disclosed is an electrical apparatus comprising any example of the disconnector described herein.

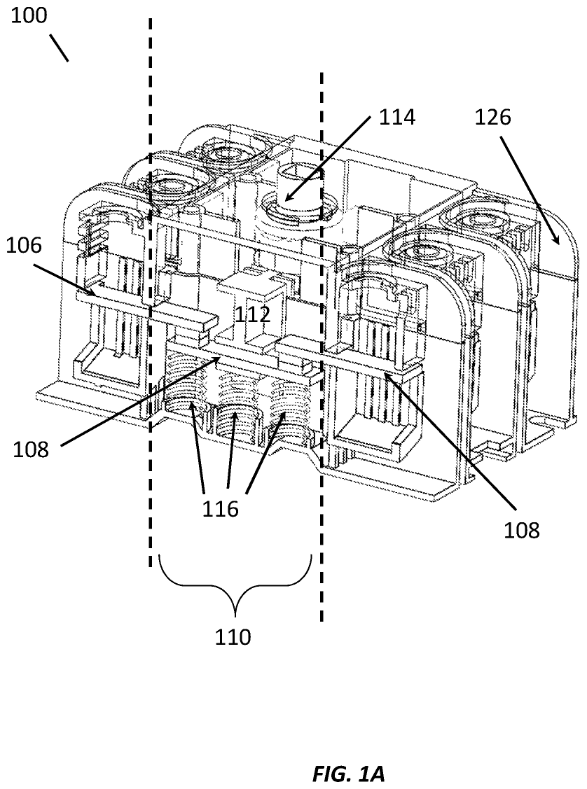

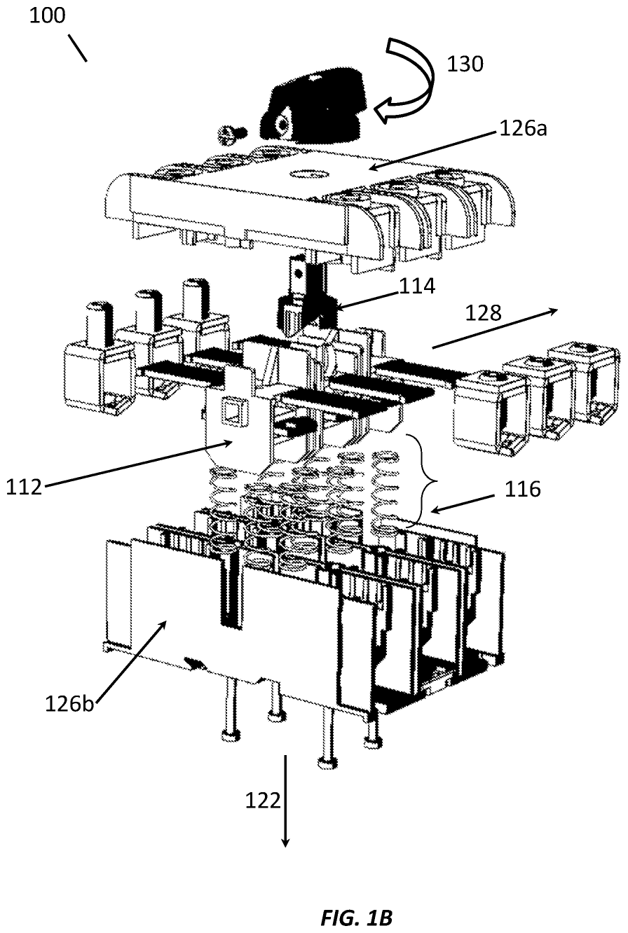

With reference to FIG. 1 (FIGS. 1A and 1B), a switch disconnector 100 for opening a current conduction path is described. Switch-disconnector 100 is described herein as a switch-disconnector to isolate an electrical component (which can be after a current has been interrupted by another control device if the switch-disconnector has a low load capability), although it will be understood that the principles described herein could be applied to a load or switch switch-disconnector or circuit breaker or any other form of electrical disconnection device.

Switch disconnector 100 comprises a switch 102, the switch 102 comprising a first contact terminal 104 of a first conductor, a second contact terminal 106 of a second conductor, and bridge contact 108. These components are separate, conducting, components of the switch, arranged to define a current conduction path (when the contact terminals 104, 106 are electrically connected to an external circuit upon installation of the switch-disconnector 100) by way of electrical contact between the first and second contact terminals 104, 106 and the bridge contact 108.

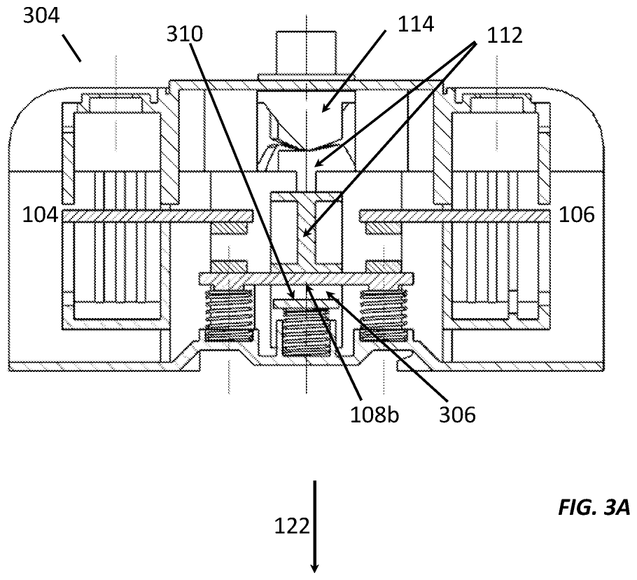

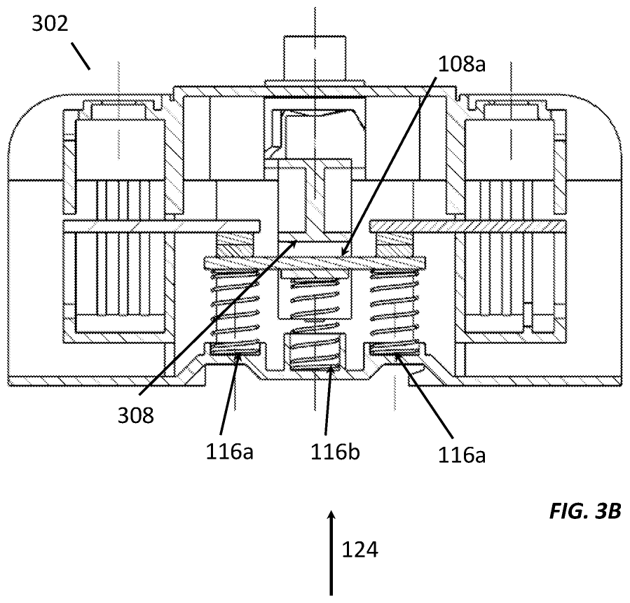

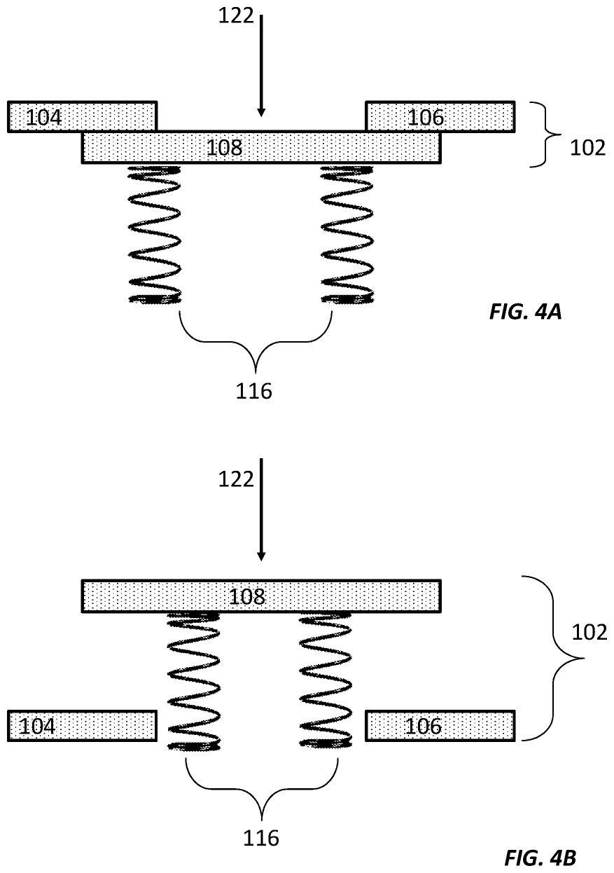

The first and second contact terminals 104, 106 are fixed, rigid, components of the switch 142, and the bridge contact 108 is a moveable switching component. For example, in a first position of the bridge contact 108, the bridge contact and first and second contact terminals 104, 106 are in electrical contact and define the current conduction path. In this position, the switch is closed and current can flow through the switch 102. In this example, movement of the bridge contact 108 in a direction 122 towards a second position, in which the bridge contact and first and second contact terminals 104, 106 are electrically separate, opens the switch 102. Opening the switch 102 breaks the current conduction path and isolates from its power source any apparatus which is connected to the electrical circuit on which the switch-disconnector is arranged. In particular, actuation of the bridge contact 108 in the direction 122 causes this electrical separation to occur by way of the physical separation of the bridge contact 108 from the first and second contact terminals. This operation is described in more detail below with reference to FIGS. 3 and 4.

Switch-disconnector 100 further comprises a housing 126, enclosing at least the components of switch 102. In particular, the first and second contact terminals 104, 106 of conductors and the bridge contact 108 are disposed within the housing 126 of the switch-disconnector 100. In other words, the first and second contact terminals 104, 106 are the end portions of conductors via which the device is connected to an external circuit and are the portions which are used within the switching mechanism of a switch-disconnector, i.e. the portions which make or break the circuit. Connection of the conductors associated with the first and second contact terminals to an external circuit outside of the housing 126 of the switch-disconnector can be by way of any suitable electrical connection, and suitable openings in the housing 126 can allow for such connection.

An advantage of the disconnector arrangement described herein is that the housing 126 can be constructed in two halves; for example, the switch and actuating mechanism can be built into a lower half or base 126b of the housing (or a back half, depending on the orientation of the switch), and then a front portion 126a may be provided afterwards. In other words, housing 126 comprises two housing portions, a front/top portion 126a and a rear/bottom portion 126b. The manufacturing and construction of the switch disconnector may therefore be quicker and cheaper.

Another advantage of the disconnector arrangement described herein is that the front portion 126a of the housing may be flat (with the exception of additionally mounted rotary component, or knob, 132). In particular, since the arrangement of the actuating mechanism and switch obviates the need for the additional mechanisms used in existing disconnector devices to assist the operation of the urging member cam, the depth of the disconnector 100 (here, the thickness along direction 122) can be significantly reduced. A smaller disconnector may therefore be provided, and fewer materials may be needed for manufacturing the disconnector. The disconnector described herein may therefore be cheaper and require fewer resources to manufacture than other disconnectors.

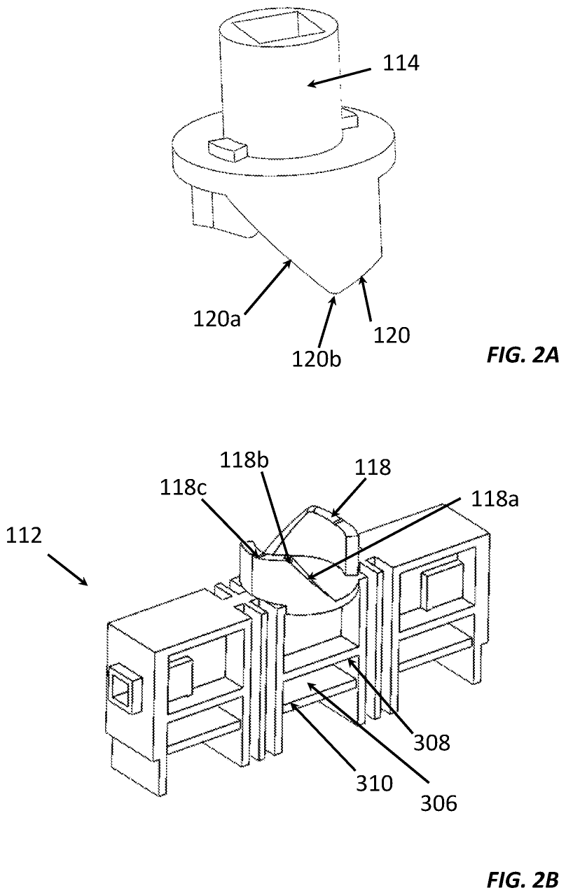

With further reference to FIG. 2 (FIGS. 2A and 2B), actuation of the bridge contact 108 is controlled by an actuating mechanism 110 of the switch-disconnector 100. In one example, a rotational movement 130 of rotary component 132 (here shown as a manually operated knob, but any other suitable component may be used) of the actuating mechanism 110 causes actuation of the bridge contact 108 in direction 122 (i.e. from the first position to the second position). In particular, the linear actuation of the bridge contact 108 in direction 122 is controlled by manual user input of the rotary component 132, and the movement of the bridge contact 108 back to the first position is independent of user input, as will be described below in more detail.

The actuating mechanism 110 comprises an urging member 114 rotatable in direction 130 around an axis extending in direction 122 (which rotation is in response to actuation of the rotary component 132 by a user). The speed of rotation of the urging number 114 in this direction is thus user dependent. The urging member 114 is configured as cam, and the actuating mechanism further comprises a cam follower 112 which is arranged such that movement of the cam follower causes a corresponding movement of the movable bridge contact 108. Optionally, the cam follower is coupled to the moveable bridge contact; this can be advantageous when rapid switch make/break is required, since user input has an instant effect on the position of the moveable bridge contact. Optionally, a portion of the cam follower is arranged around the moveable bridge contact such that the cam follower at least temporarily contacts, but is not coupled to, the moveable bridge contact 108. As described herein, the urging member 114 is fixed in the axial direction 122 and rotatable relative to the cam follower 112 to cause displacement of the cam follower (and thus of the bridge contact 108) by interaction between the cam follower and the urging member.

In particular, the urging member 114 comprises a cam surface 120, and the cam follower 112 comprises a following surface 118 along which the cam surface travels as the urging member rotates. The following surface 118 is configured to engage with the cam surface 120 to cause the cam follower 114 to move in the linear direction 122 in response to rotation 130 of the urging member 114 position (i.e. as the height of the cam surface 120 changes, the cam follower moves accordingly such that the following surface remains in contact with the cam surface), thereby moving the bridge contact 108 from the first position towards the second. This arrangement is contrary to other semi-independent or independent mechanisms, which comprise spring powered mechanisms which operate to move a contact carrying bridge in a transverse or lateral direction (i.e. in a direction perpendicular to the axial direction 122) to open a current conduction path, and can facilitate for simpler and cheaper manufacturing, since fewer components may be required. For example, the need for mechanisms and cams to separately drive the springs can be eliminated by the proposed linear arrangement of the bridge contact and biasing member. This arrangement can also provide flexibility in the arrangement for the making/breaking of the switch, as will be discussed further with reference to FIG. 4.

Moreover, the arrangement disclosed herein is contrary to other semi-independent or independent mechanisms which operate to indirectly move a contact carrying bridge in an axial direction by way of additional, cam operated, spring and/or cam powered mechanisms. For example, in some previous switch arrangements the rotation of a cam causes lateral movement (i.e. movement perpendicular to the axial direction) of a cam follower, which lateral movement can act on one or more spring mechanisms to indirectly actuate the bridge contact in a different direction. In contrast, the present, linear, arrangement allows the rotation of the urging member or cam component to directly displace the cam follower in the axial direction and therefore directly actuate or more the bridge contact, and so eliminates the need for such additional cam or spring based mechanisms. By removing the need to translate movement between different directions during operation, a smaller and simpler device may be provided.

In order to urge the moveable bridge contact 108 in direction 122, i.e. in order to provide a force to the bridge contact 108 to move it in direction 122, at least one of the following surface and the cam surface comprises an angled portion 118a, 120a. As the urging member 114 rotates in direction 130, the angled portion 120a of the cam surface 120 can rotate along the following surface 118 of the cam follower 112 (or the cam surface 120 can rotate along the angled portion 118a of the following surface 118); the fixed position of the urging member 112 in combination with the rotation of the angled portion 118a or 120a relative to the other surface causes the cam follower 112 to move in the axial direction 122.

The at least one angled portion can be a straight angled portion, or the cam(s) can be arranged to comprise at least one helical or spiral portion. The at least one angled portion is angled with respect to the axial direction 122, and may be arranged at a constant or varying angle depending on the geometry of the components. In some examples, the angled portion(s) 118a, 120a can both be angled at between 30 degrees and 60 degrees relative to direction 122, optionally angled at between 40 and 50 degrees, optionally angled at 45 degrees or substantially at 45 degrees. Optionally, the angled portions can be at smaller or greater angles relative to the direction 122, as appropriate. It will be understood that the angle of the angled portion with respect to direction 122 influences the force required to operate the switch, as well as the amount of displacement provided per degree of rotation of the rotary component 132. The cam geometries, including the angle of the angled portion, may therefore be chosen for a particular application. As described herein, the cams may be designed such that each comprises an angled portion, wherein the two angled portions are arranged to correspond to one another, such that the surfaces of the cams may be in contact along the entire length of the angled portion.

The actuating mechanism 110 further comprises a biasing member 116, configured to act on the movable bridge contact 108 to oppose its movement in the axial direction 122. In other words, the biasing member 116 exerts a force on the movable bridge contact 108, and/or on the cam follower 112 which at least temporarily contacts the bridge contact 108, the force being exerted in direction 124 opposite to direction 122 when the bridge contact is actuated. The force exerted by the biasing member 116 is less than the force exerted by the urging member 114, such that manual actuation of the rotatable component 132 causes an opening of the current conduction path by displacement of the movable bridge contact 108, described above. However, the force exerted in direction 124 is sufficient to move the movable contact 108 back to the first position in the absence of any user input. In this way, independent closing (making) of the switch 102 is provided.

The biasing member 116 is shown here as a series of springs (see FIG. 1A), but the biasing member may be any other resiliently deformable member configured to exert a force in direction 124 in response to compression or other deformation caused by movement the bridge contact 108. For example, a flexible arm or leaf spring may be used and/or a rubber or elastic members arranged under tension or compression. It will be understood that the resiliently deformable member, shown here under compression, can also be arranged under tension; for example, as the bridge contact 108 is displaced in direction 122, the biasing member may be placed in extension, with a restoring force being exerted in direction 124. For example, a spring or rubber or elastic remember may be stretched as the bridge contact 108 moves. It will be understood that the force exerted by the biasing member may be sufficient that the disconnector 100 can be placed in any orientation. For example, the disconnector may be orientated such that direction 122 is perpendicular to the arrangement shown in FIG. 1A. Utility of the switch disconnector may therefore be improved.

In the example described herein, a series of three springs, arranged equidistant along the length of the movable bridge contact 108, are provided. In some examples, the cam follower 112 is coupled to the moveable bridge contact, such that movement of the cam follower 112 directly moves the moveable bridge contact 108. Each spring is configured to compress as the movable bridge contact is urged in the axial direction 122, and therefore to exert an opposing force in direction 124. However, it will be understood that two springs may be provided, one at each end of the bridge contact 108. Alternatively, a single spring may be provided, optionally in the middle of the bridge contact 108. The number and arrangement of the springs, or other biasing members 116, can be determined based on the particular application. For example, more springs may improve contact between the components of the switch 102, and/or increase the reliability of the making operation (or breaking operation, as described below) by controlling the movement of the bridge contact 108. However, for some applications fewer springs or a smaller biasing member may be a suitable trade-off for a lower cost, low complexity device.

As can be seen further with reference to FIG. 3A, in some examples described herein there are three springs, which springs can fulfil different functions at different parts of the break operation. For example, it can be seen that two of the springs (the ones at either end of the bridge contact 108) are located beneath the moveable bridge contact 108; these are springs 116a. Springs 116a may be in direct physical contact with the bridge contact 108, or may be in indirect contact, for example via an insulating portion. The middle spring 116b is arranged beneath the middle of the bridge contact 108, but is in contact with the cam follower 112 rather than the bridge contact 108 itself.

When the urging member or cam 114 is rotated in direction 130 (here, direction 130 is anticlockwise), spring 116b associated with the cam follower 112 is activated, and is compressed until a portion of cam follower 112 contacts the movable bridge contact 108 (see FIG. 3A for further description of the arrangement of the cam follower), wherein the cam follower 112 begins to urge the moveable bridge contact 108 with it along direction 122. This movement of the bridge contact subsequently causes springs 116a to begin to compress. All three springs of the biasing member 116 are then providing a restoring force on the cam follower 112 due to the contact between the bridge contact and the cam follower in anticipation of a subsequent switch make operation.

In other words, the biasing member comprises three springs arranged equidistant along a length of the moveable bridge contact; each is configured to compress as the moveable bridge contact is urged in the axial direction, but in response to different initial inputs. A middle spring 116b of the three springs is configured to compress as the cam follower is urged in the axial direction, and the other two springs 116a (the end springs) are configured to subsequently compress only when the moveable bridge contact 108 moves,

i.e. after a predetermined displacement of the cam follower causes a portion of the cam follower to contact the moveable bridge contact and begin urging it in the axial direction. This arrangement can facilitate a more robust switch, since small or accidental inputs do not cause breaking of the circuit through the switch (instead, switch 116b can absorb said small inputs, and only large inputs which cause sufficient displacement of the cam follower that it contacts the bridge contact act to trigger the disconnector 100).

In some examples, the cam surface 120 can comprise a protruding portion 120b which contacts the angled portion 118a as the urging member 114 rotates. The following surface 118 comprising the angled portion 118a follows the movement of the protruding portion 120b of the cam surface. In particular, the biasing member 116 exerts a force on the cam follower in direction 124 which pushes the following surface into the cam surface; the interplay between downward force from user controlled urging member 14 and the upward force from the biasing member 116 ensures a contact between the following and cam surfaces during operation of the disconnector 100. Additionally or alternatively, the following surface 118 can comprise a protruding 118b or flat portion which contacts angled portion 120a of the cam surface 120. In some examples, both the following surface and the cam surface comprise corresponding angled portions which are in contact with one another when the movable bridge contact 108 is in the first position. In this way, a smaller switch may be provided, since the respective angled portions of the urging member and the cam follower can mate when the bridge contact is in the first position.

In some arrangements, the protruding portion of the cam surface is arranged to be received within a detent or recess 118c in the following surface 118. When the protruding portion 120b is received by the detent 118c, a stop position of the urging member 114 is defined. In other words, the stop position can be considered as the position of the urging member 114 when the protruding portion 120b and the recess, or detent, 118c are aligned. In the arrangements described herein, the urging member rotates 90 degrees in direction 130 before reaching the stop position. However, it will be understood that depending on the cam arrangement and geometry, more or less rotation may be provided by a user before a stop position is reached. Moreover, to return the bridge contact to the first position, the rotation can be in a direction opposite direction 130 or the urging member 114 may continue to rotate in direction 130, depending on the particular cam configurations used.

It will also be understood that, in some examples, rotation of the urging member 114 in a first direction (direction 130) to the stop position may be at least partially user independent. In particular, in examples where a user rotates the urging member until the protruding portion 120b of the cam surface is aligned with protruding portion 118b of the following surface (the point of maximum compression of the biasing member, where the bridge contact is at maximum displacement from the rest of the switch), further rotation of the urging member may be user independent due to the angled portion of the following surface which extends between protruding portion 118b and recess 118c. This angled portion of the following surface causes the protruding portion 120b to follow the following surface to recess 118c and the stop position without any user input.

At the stop position, movement of the bridge contact 108 under the opposing force of the biasing member 116 is prevented. The detent prevents further rotation of the urging member 114, in either direction, without manual input. Should a user wish to move the bridge contact 108 back to the second position, an initial input can be provided to release the protruding portion 120b from the detent 118c; the biasing member 116 then applies a force in direction 124, causing the cam follower to move in direction 124. In the present examples, the cam follower 112 acts to urge the urging member 114 to rotate in a direction opposite to direction 130, which rotation is facilitated by the at least one angled portion 118a, 120a (the cam surface can slide along the following surface as the urging member rotates). In other arrangements, the detent can be provided on the cam surface (rather than the following surface), with a corresponding protruding portion 118b on the following surface. Depending on the cam geometry or arrangement, further rotation of the urging member in direction 130 may also/instead release the urging member from the stop position and cause the bridge contact to return to the first position under the force of the biasing member 116.

In some arrangements, a protruding portion 118b is provided in combination with the detent 118c on the following surface 118, along with the protruding portion 120b of the cam surface 120 (it will be understood that the features described with reference to the cam surface may be otherwise provided on the following surface, and vice versa). By providing such a protruding portion on the following surface, here located between the angled portion 118a and the detent 118c, the protruding portion 120b has to travel over the protruding portion 118b before reaching the stop position in detent 118c. When the two protruding portions of the cams contact, a maximum compression (or tension) of the biasing member 116 can be applied; the subsequent release of the biasing member 116 as the protruding portion the urging member travels towards the stop position at the detent or recess 118c can provide a physical feedback to the user that the stop position is reached. This can improve reliability of operation of the disconnector and so improve safety.

As illustrated in FIG. 1B, the switch disconnector 100 comprises three separate switches 102, arranged along a direction 128 perpendicular to axial direction 122. In the examples illustrated herein, each separate switch 102 comprises a separate biasing member 116 (in this arrangement, a set of three individuals springs aligned along a length of each bridge contact 108). However, it will be understood that a single biasing member 116 may be provided for the entire series of switches 102. The number and positional relationship of the switches 102 can be determined by the particular application for the switch disconnector 100, such as the size of the switch and/or the rating capacity; in some examples, there may be only one switch 102, there may be two switches 102, there may be three switches, or three or more switches, et cetera.

As illustrated in FIG. 2B, which shows the cam follower of the arrangement FIG. 1B, the cam follower 112 comprises three sections, each of which supports a separate one of the three bridge contacts 108. In this way, each switch 102 of the disconnector 100 may be operated simultaneously in response to actuation of a single urging member 114 by rotary component 132. However, it will be understood that when multiple switches 102 are provided within a single housing 126, each switch may be individually actuated with a separate actuating mechanism 110 in the manner described herein.

The first position 302 and the second position 304 of the movable bridge contact is described further with reference to FIGS. 3A and 3B. As discussed above, in the first position 302 of the bridge contact 108, the bridge contact and first and second contact terminals 104, 106 are in electrical contact and define the current conduction path. In this position, the switch is closed and current can flow through the switch 102 (see e.g. FIG. 3B). The cam surface and the following surface of the urging member and the cam follower, respectively, each comprise an angled portion 118a, 120a. The cam (or urging member) and cam follower are arranged such that the two angled portions are aligned and the cam surface and the following surface are in contact along at least the angled portions. This minimizes the depth of the switch disconnector 100, facilitating provision of a smaller disconnector device.

Upon rotation of the rotary component 132 by a user, the urging member forces the cam follower in direction 122. In other words, by rotating the rotary component in a first direction 130, the urging member 114 is rotated around the axial direction 122 relative to the cam follower, optionally until a stop position is reached. Rotating the urging member urges the cam follower in the axial direction. This urging can compress (or tension, as appropriate) a portion of the biasing member (here spring 116b) which is coupled to, or arranged in contact with, the cam follower 112.

The cam follower here comprises a void 306 in which the moveable bridge contact 108 is located, the void bounded along direction 122 by first 308 and second 310 surfaces (see also FIG. 2B). It will be understood that the protection against accidental rotation or input provided by the device can be in part dependent on the dimensions of the void—a greater void depth along the axial direction 122 (i.e. between first surface 308 and second surface 310) means the cam follower must travel further before contacting the moveable bridge contact, so a greater degree of rotation needs to be applied by a user before the switch is activated. The protection against accidental operation may therefore be predetermined or preconfigured by changing the void dimensions.

As the cam follower is urged in the axial direction 122, the first surface 308 contacts a surface 108a of the moveable bridge contact. The urging of the cam follower 112 causes surface 308 to push down on surface 108a, which pushing causes a temporary contact between the cam follower and the bridge contact, and a corresponding movement of the moveable bridge contact 108 in direction 122. As the bridge contact 108 moves, another portion of the biasing member (here springs 116a) compresses (or tensions, as appropriate), which causes the biasing member 116 to oppose the urging of the moveable bridge 108. Without sustained user input, the biasing member will thus force the moveable bridge 108 back to the first position 302. For this reason, the detent is provided. In other examples the bridge contact 108 is coupled (optionally rigidly) to the cam follower 112, and is correspondingly moved in direction 122 towards the second position 304 shown in FIG. 3A in response to the urging of the cam follower.

In the second position 304, the bridge contact 108 and first and second contact terminals 104, 106 are electrically separate, which opens the switch 102. This is the switch break operation. Opening the switch 102 breaks the current conduction path and isolates from its power source any apparatus which is connected to the electrical circuit on which the switch-disconnector is arranged. In particular, actuation of the bridge contact 108 in the direction 122 causes this electrical separation to occur by way of the physical separation of the bridge contact 108 from the first and second contact terminals by the relative motions of the urging member cam and the cam follower.

During the corresponding make operation, the biasing member exerts a restoring force on the cam follower 112 and the bridge contact 108 in direction 124 (see FIG. 3B). As the moveable member and cam follower are moved back towards the first position, the second surface 310 bounding void 306 can temporarily contact a second surface 108b of the moveable bridge contact, which contact can help to improve stability of movement of the bridge contact during the make operation (by supporting the middle of the bridge contact, as well as the ends). The force applied by the portions of biasing member 116 acting directly on the bridge contact 108 (here springs 116a) can help to ensure good electrical contact between the bridge contact 108 and the first and second fixed contacts 104, 106 when the switch is closed.

Movement of the moveable bridge contact towards the first position by the biasing mechanism (here, the make operation) is at least partially independent of user input.

In the examples described herein, the make operation occurs in response to an initial user input (to release the protruding portion from the detent, as discussed above, and thereby release the urging member from the stop position). After rotating the urging member in a second direction opposite to the first direction to rotate the urging member past the stop position, the biasing member 116 acts to move the moveable bridge in direction 124 towards the first position to close the switch; in particular, the restoring force of the biasing member 116 axis direction 122 to restore the biasing member from the compression (or tension) to which it has been subject whilst the bridge contact 108 was retained in the second position 304. In this regard, the make operation is (for the most part) independent of user input. This arrangement can provide a controlled break operation, and an at least partially independent make operation. This allows the switch make to be achieved quickly, which can be of benefit in applications were rapid electrical connection is required.

The switch disconnector 100 of FIGS. 3A and 3B is illustrated further in FIG. 4A. As can be seen from this schematic, the first and second fixed contacts 106, 108 are arranged between the cam follower 112 and the moveable bridge contact 108 (i.e. the bridge contact 108 is further away from the cam follower 112 in direction 122 than the fixed contacts 106, 108).

An alternative switch disconnector is illustrated in FIG. 4B, in which the moveable bridge contact 108 is arranged between the cam follower 112 and the first and second fixed contacts 104, 106 (i.e. the bridge contact 108 is closer to the cam follower 112 in direction 122 than the fixed contacts 106, 108). In this arrangement, in the first position (where the urging member 114 and the cam follower 112 are mated and the biasing member 116 is under no tension or compression) the moveable bridge contact 108 is electrically and physically separate from the first and second fixed contact terminals 104, 106 and the current conduction path is open.

In the second position (i.e. where the urging member is in the stop position and the biasing member is compressed, or under tension, as appropriate) the moveable bridge contact is in electrical contact with the first and second fixed contact terminals to define a current conduction path between the first conductor and the second conductor. As an alternative to the arrangement of FIG. 4A, this arrangement can provide a controlled make operation (since the displacement in direction 122 is user input dependent), and an at least partially user independent break operation, where the break operation is, after the initial release of the urging member from the recess 118c at the stop position, under the control of the biasing member 116. This allows the switch break to be achieved quickly, which can be of benefit in applications were rapid disconnection is required.

It is noted herein that while the above describes various examples of the isolating or disconnector switch of the first aspect, these descriptions should not be viewed in a limiting sense. Rather, there are several variations and modifications which may be made without departing from the scope of the present invention as defined herein.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A disconnector, comprising:
a switch, comprising:
a first, fixed contact terminal of a first conductor,
a second, fixed contact terminal of a second conductor, and
a moveable bridge contact moveable between a first position and a second position; and
an actuating mechanism, comprising:
a cam follower coupled to the moveable bridge contact and comprising a following surface,
a cam comprising a cam surface, the cam surface being configured to engage with the following surface, the cam being rotatable around an axial direction relative to the cam follower,
wherein at least one of the following surface and the cam surface comprises an angled portion, the angled portion angled with respect to the axial direction such that rotation of the cam urges the cam follower in the axial direction, the cam follower being configured to move the moveable bridge contact in the axial direction from the first position to the second position in response to the urging, and
wherein the disconnector further comprises two biasing members configured to, upon movement of the moveable bridge contact in the axial direction, exert a force on the moveable bridge contact in a direction opposite the axial direction to oppose the movement, one biasing member being arranged at each end of the moveable bridge contact.

2: The disconnector of claim 1, wherein the two biasing member are resiliently deformable.

3. (canceled)

4: The disconnector of claim 1, wherein the two biasing members comprise two springs, one spring arranged at each end of the moveable bridge contact, each spring being configured to compress as the moveable bridge contact is urged in the axial direction.

5: The disconnector of claim 1, wherein the first and second fixed contacts are arranged between the cam follower and the moveable bridge contact, such that:
in the first position, the moveable bridge contact is in electrical contact with the first and second fixed contact terminals to define a current conduction path between the first conductor and the second conductor, and
in the second position, the moveable bridge contact is electrically and physically separate from the first and second fixed contact terminals and the current conduction path is open.

6: The disconnector of claim 1, wherein the moveable bridge contact is arranged between the cam follower and the first and second fixed contacts, such that:
in the second position, the moveable bridge contact is in electrical contact with the first and second fixed contact terminals to define a current conduction path between the first conductor and the second conductor, and
in the first position, the moveable bridge contact is electrically and physically separate from the first and second fixed contact terminals and the current conduction path is open.

7: The disconnector of claim 1, wherein the cam surface comprises a protruding portion and the following surface comprises a detent, the protruding portion being configured to be received by the detent to define a stop position of the cam, and
wherein, when the cam is in the stop position, the moveable bridge contact is in the second position.

8: The disconnector of claim 1, wherein the cam is fixed in the axial direction.

9: The disconnector of claim 1, wherein both the following surface and the cam surface comprise corresponding angled portions which are in contact with one another when the moveable bridge contact is in the first position.

10: The disconnector of claim 9, wherein the following surface and the cam surface are in contact with one another along an entire length of the angled portion when the moveable bridge contact is in the first position.

11: The disconnector of claim 1, wherein the angled portion is angled such that the urging of the moveable bridge contact in the axial direction from the first position to the second position is dependent on user input, and movement of the moveable bridge contact towards the first position by the biasing mechanism is at least partially independent of user input.

12: The disconnector of claim 1, further comprising:
a second switch,
wherein the cam follower is configured to move the moveable bridge contact of the second switch in response to the urging, and
wherein the actuating mechanism comprises a second biasing member configured to exert a force on the moveable bridge member of the second switch.

13: The disconnector of claim 12, wherein the switch and the second switch are arranged along a direction perpendicular to the axial direction.

14: A method of operating a disconnector, comprising:
rotating a cam in a first direction around an axial direction relative to a cam follower, the cam comprising a cam surface and the cam follower comprising a following surface, the cam surface being configured to engage with the following surface, at least one of the following surface and the cam surface comprising an angled portion, the angled portion being angled with respect to the axial direction; and
in response to the rotating:
urging the cam follower in the axial direction to urge a moveable bridge contact of a switch in the axial direction from a first position to a second position to open or close the switch, the moveable bridge contact being configured to move in response to the urging of the cam follower, and
upon movement of the moveable bridge contact in the axial direction, exerting, with two biasing member, a force on the moveable bridge contact in a direction opposite the axial direction to oppose the movement, one biasing member being arranged at each end of the moveable bridge contact.

15: The method of claim 14, wherein rotating the cam in the first direction comprises rotating in the first direction to a stop position,
wherein the method further comprises:
rotating the cam in a second direction opposite to the first direction to rotate the cam past the stop position; and
moving, by the two biasing members, the moveable bridge contact towards the first position to close or open the switch.

16: The disconnector of claim 4, further comprising a middle spring arranged between the two springs,
wherein the middle spring is in contact with the cam follower and is initially configured to compress as the cam follower is urged in the axial direction.
